(19) United States
(12) Patent Application Publication
(10) Pub. No.: US 2014/0340566 A1
(43) Pub. Date: Nov. 20, 2014

(54) IMAGING DEVICE

(71) Applicants: Shane D. Voss, Fort Collins, CO (US); Jason Yost, Windsor, CO (US)

(72) Inventors: Shane D. Voss, Fort Collins, CO (US); Jason Yost, Windsor, CO (US)

(21) Appl. No.: 14/345,282

(22) PCT Filed: Oct. 18, 2011
(86) PCT No.: PCT/US2011/056706

§ 371 Date: Mar. 17, 2014

(51) Int. Cl. H04N 5/232; H04N 5/225

(52) U.S. Cl. CPC H04N 5/23212; H04N 5/2254
USPC 348/349

(57) ABSTRACT

Example embodiments disclosed herein relate to an imaging device and method. One example of such an imaging device includes a focus imaging unit and a camera imaging unit. The camera imaging unit is separate from the focus imaging unit and is configured to record an image. The imaging device additionally includes a focusing unit coupled to the focus imaging unit and the camera imaging unit. This focusing unit is configured to adjust a focus position of the focus imaging unit and the camera imaging unit. The imaging device further includes a control unit that is configured to actuate the focusing unit to adjust the focus position of the focus imaging unit and to thereby determine an optimal focus position, and to actuate the focusing unit to adjust the focus position of the camera imaging unit based on the determined optimal focus position.

### BACKGROUND

A challenge exists to deliver quality and value to consumers, for example, by providing imaging devices such as cameras that are cost effective. Additionally, businesses may desire to provide new features for such imaging devices. Further, businesses may desire to enhance the performance of one or more components of such imaging devices.

### BRIEF DESCRIPTION OF THE DRAWINGS

The following detailed description references the drawings, wherein:

FIG. 1 shows a block diagram of an example of an imaging device.

FIG. 2 shows a block diagram of another example of an imaging device.

FIG. 3 illustrates an example of a contrast analysis technique.

FIG. 4 illustrates an example of a method for use in an imaging device.

FIG. 5 shows an example of additional method elements for use in an imaging device.

FIG. 6 shows an example of a hand-held device that includes an imaging device.

### DETAILED DESCRIPTION

Imaging devices, such as cameras, include a lens assembly that focuses on an object within its field of view to provide a sharp image of the object on the sensor or film plane of the imaging device. This focusing is automatic in many imaging devices. In such imaging devices, the image can go in and out of focus for a period of time as the focus motor moves through its range of positions during selection of the optimal focus. This is sometimes referred to as focus hunt.

Also, for some lens designs, moving the focus position of the lens can cause a small, but noticeable, magnification effect on video images for video camera imaging devices. This can cause objects within the video images to appear to change size. Additionally, as a result of such magnification, objects located near the edges of video frames at one lens focus position may or may not be in the video frame as the lens focus position is changed during focus hunting. This can be an issue for end users if the subject goes in and out of the video frames.

These above-described issues can be minimized by limiting the movement of the lens during focus hunting. A problem with this approach, however, is that sufficient time may not be provided to determine the optimal focus location for a given image.

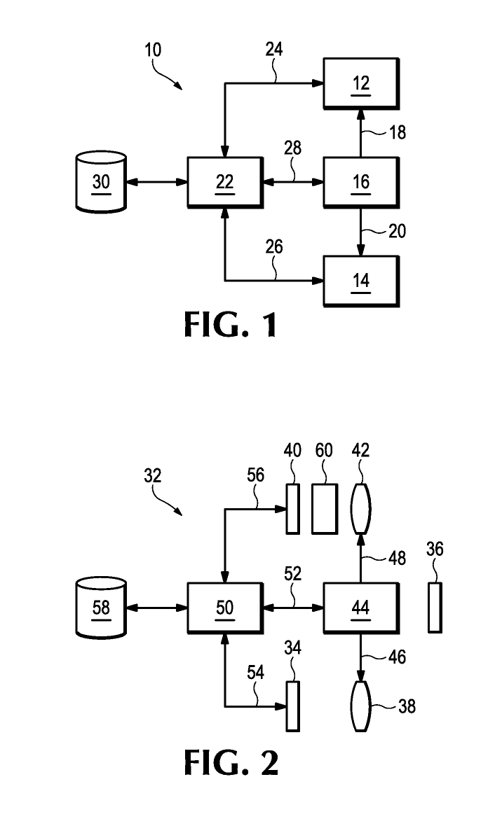

A block diagram of an example of an imaging device 10 designed to address some of these above-described issues is shown in FIG. 1. Imaging device 10 includes a focus imaging unit 12 and a separate camera imaging unit 14 that is configured to record an image. Camera imaging unit 14 may be designed to capture still images or video. As illustrated in FIG. 1, imaging device 10 also includes a focusing unit 16 that is coupled to focus imaging unit 12 and camera imaging unit 14, as generally indicated by respective arrows 18 and 20. Focusing unit 16 is configured to adjust a focus position of focus imaging unit 12 and camera imaging unit 14. Imaging device 10 additionally includes a control unit 22 that is coupled to focus imaging unit 12, camera imaging unit 14 and focusing unit 16, as generally indicated by respective arrows 24, 26, and 28. Control unit 22 is configured to actuate focusing unit 16 to adjust the focus position of focus imaging unit 12 and, to thereby, determine an optimal focus position. Control unit 22 is further configured to actuate focusing unit 16 to adjust the focus position of camera imaging unit 14 based on the determined optimal focus position.

As can be seen in FIG. 1, imaging device 10 may include a non-transitory computer-readable storage medium 30 that stores instructions which are executed by a processor, in this case control unit 22. Non-transitory computer-readable storage medium 30 may include any type of non-volatile memory such as a hard drive, diskette, CD ROM, flash drive, etc. Furthermore, control unit 22 may include any type of computing device such as microprocessor, field-programmable gate array (FPGA), application specific integrated circuit (ASIC), etc.

Another example of a block diagram of an imaging device 32 is illustrated in FIG. 2. Imaging device 32 includes a focus sensor 34 that is configured to record an image of an object 36 and a focus lens 38 that is configured to position the image on focus sensor 34. Focus sensor 34 may be designed to capture still images or video. Focus lens 38 may include one or more optical elements. Imaging device 32 additionally includes a camera sensor 40 that is also configured to record a separate image of object 36 and a camera lens 42 that is configured to position the separate image on camera sensor 40. Camera sensor 40 may be designed to capture still images or video. Camera lens 42 may also include one or more optical elements. Imaging device 32 also includes a focusing assembly 44 coupled to focus lens 38 and camera lens 42, as generally indicated by respective arrows 46 and 48. Focusing assembly 44 is configured to adjust both placement of the image of object 36 on focus sensor 34 and placement of the separate image of object 36 on camera sensor 40. Imaging device 32 further includes a control unit 50 coupled to focusing assembly 44, focus sensor 34 and camera sensor 40, as generally indicated by respective arrows 52, 54, and 56. Control unit 50 is configured to actuate focusing assembly 44 to determine an optimal focus of the image of object 36 on focus sensor 34. Control unit 50 is additionally configured to actuate focusing assembly 44 to adjust the placement of the separate image of object 36 on camera sensor 40 based on the determined optimal focus.

As can be seen in FIG. 2, imaging device 32 may also include a non-transitory computer-readable storage medium 58 that stores instructions which are executed by a processor, in this case control unit 50. Non-transitory computer-readable storage medium 58 may include any type of non-volatile memory such as a hard drive, diskette, CD ROM, flash drive, etc. Furthermore, control unit 50 may include any type of computing device such as microprocessor, field-programmable gate array (FPGA), application specific integrated circuit (ASIC), etc.

A filter unit 60 may be positioned between camera sensor 40 and camera lens 42. Filter unit 60 may include a plurality of colored filters such as a red filter, a green filter, and a blue filter. This allows camera sensor 40 to record polychromatic light while focus sensor 34 is only able to record monochromatic light. This helps optimize camera sensor 40 for recording images while still allowing focus sensor 34 to be optimized for focusing. It also provides increased low light focusing performance for focus sensor 34 because colored filters would block some of this light before it reached focus sensor 34. Although not shown, it is to be understood that the filters of filter unit 60 may be directly incorporated into camera sensor 40, rather than being a separate component.

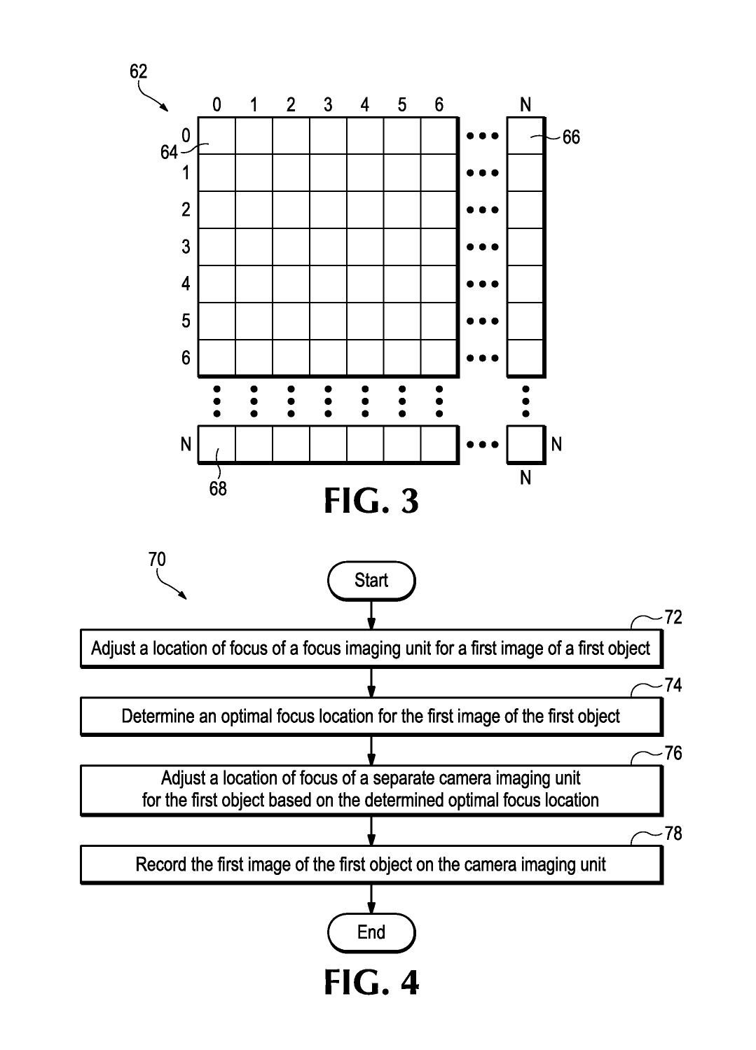

Both focus imaging unit 12 and focus sensor 34 rely on passive focusing by measuring contrast differences in an image. An example of a contrast analysis or measurement technique is shown in FIG. 3. In this example, the sum of the squares of the differences between all neighboring pixels is used. As can be seen in FIG. 3, each row 64 has pixels 0 through N 66. The sum for row 64 is:

$${Sum}_{row 64} = {\sum }_{i = 1}^{N} {( pixel [ i ] - pixel [ i - 1 ] )}^{2}$$

The sum of all rows from row 64 to row N 68 is then accumulated to provide a contrast measurement. This sum is highest when the focus of focus imaging unit 12 or focus sensor 34, as applicable, is sharpest. This sum decreases steadily as the lens of focus imaging unit 12 or focus lens 38 is moved by respective focusing unit 16 or focusing assembly 44 in either direction away from the sharpest focus. This contrast analysis or measurement technique may be performed solely by focus imaging unit 12 and focus sensor 34 or in combination with respective control unit 22 or control unit 50.

Separating the focusing from the imaging in accordance with the present invention has several advantages. It allows the components of an imaging system to be optimized for a particular task and it also allows separate control of these components. For example, if an image of a particular object is underexposed under given lighting conditions, the exposure time for focusing can be increased to both reduce image noise and increase the focus contrast signal which helps in the determination of the optimal focus. This may cause overexposed areas on the focus sensor, but this is of no concern because imaging is done separately and the exposure time for this component does not need to be increased. As another example, if an image of a particular object is overexposed or has bright highlights under given lighting conditions, the exposure time for focusing can be decreased to decrease the image saturation which helps in the determination of the optimal focus under such conditions. This may cause underexposed areas on the focus sensor, but this is of no concern because imaging is done separately and the exposure time for this component does not need to be decreased. Additionally the exposure time for focusing may be made shorter to reduce image blur which will help in determining optimal focus. This may cause underexposed areas on the focus sensor, but this is of no concern because imaging is done separately and the exposure time for this component does not need to be decreased.

As an additional example, the frame rate used for focusing can be greater than that used for imaging (e.g., 120 frames per second for focusing and 30 frames per second for video imaging). This allows the focusing unit of an imaging device to hunt for the optimum focus much faster (e.g. four times faster in this example) than if imaging and focusing are combined. As a further example, a higher resolution sensor may be used for focusing than for imaging. This allows more precision in determining the optimal focus location for a image of an object. Other modifications and techniques may be used as well. For example, in low light, a low resolution focusing sensor can be used. By using the relatively larger pixels of a low resolution focusing sensor, signal-to-noise can be improved which helps increase the accuracy of the contrast analysis during determination of the optimal focus.

An example of a method for use in an imaging device 70 is shown in FIG. 4. As can be seen in FIG. 4, method 70 starts by adjusting a location of focus of a focus imaging unit for a first image of a first object 72. Method 70 next determines an optimal focus location for the first image of the first object 74. Method 70 then adjusts a location of focus of a separate camera imaging unit for the first object based on the determined optimal focus location 76. Finally, method 70 records the first image of the first object on the camera imaging unit 78 and then ends.

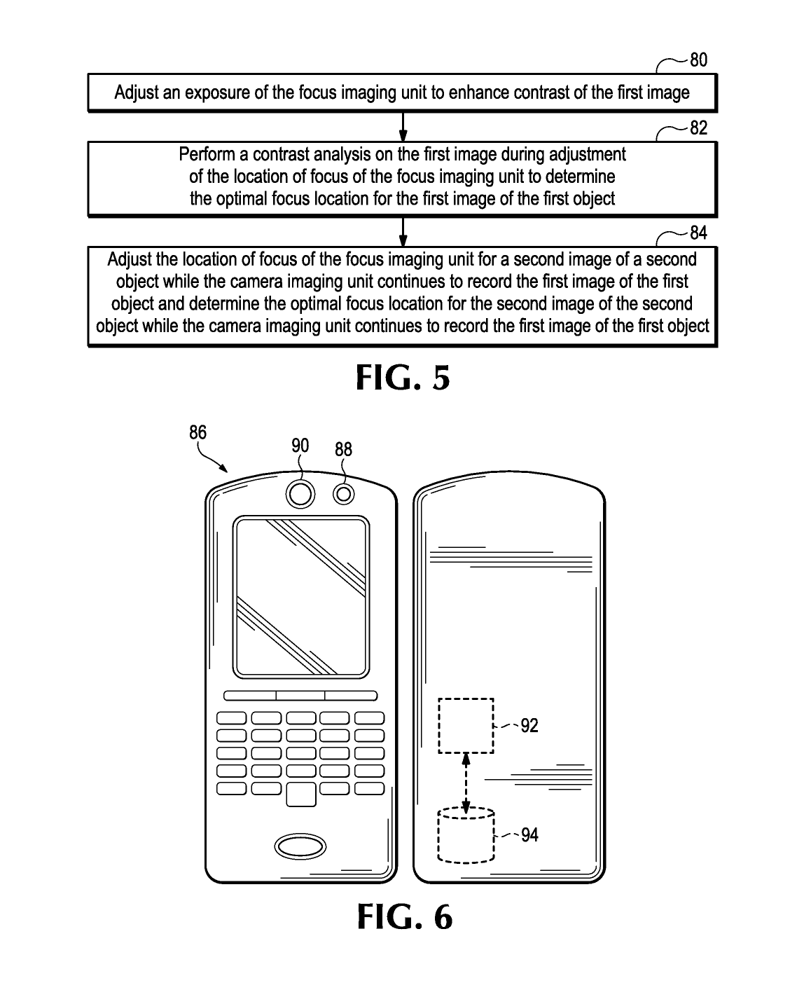

As can be seen in FIG. 5, method 70 may additionally include adjusting an exposure of the focus imaging unit to enhance contrast of the first image 80. Method 70 may additionally include performing a contrast analysis on the first image during adjustment of the location of focus of the focus imaging unit to determine the optimal focus location for the first image of the first object 82. Method 70 may further include the element of adjusting the location of focus of the focus imaging unit for a second image of a second object while the camera imaging unit continues to record the first image of the first object and determining the optimal focus location for the second image of the second object while the camera imaging unit continues to record the first image of the first object.

FIG. 6 shows a hand-held device 86 (in this example a phone) that includes an embodiment of an imaging device of the present invention. As can be seen in FIG. 6, hand-held device 86 includes a focus lens assembly 88 and a camera lens assembly 90. Hand-held device 86 additionally includes a control unit 92 and a non-transitory computer-readable storage medium 94 that stores instructions for execution by control unit 92. Although not shown in FIG. 6, it is to be understood that hand-held device 86 additionally includes the above-described focus sensor, focusing unit, and camera sensor of the imaging device of the present invention. These can be separate units within hand-held device 86 or integrated as a part of control unit 92. The imaging device of hand-held device 86 may record still images or video, depending on user preference, and can include other components as well such as the above-described filter unit.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. For example, the imaging device of the present invention may be used in other hand-held devices such as video cameras, personal digital assistants (PDAs) and tablets. As another example, the focusing unit can be configured to determine the focus location of more than one object or target within a scene. This can be done by tracking the vertical and horizontal locations of multiple objects within a scene and then sequentially determining the optimal focus location for each region that contains such a target. This allows rapid transition from a first object to a second object when the first object leaves the scene. The spirit and scope of the present invention are to be limited only by the terms of the following claims. As a further example, the field of view for the focus imaging unit may be made greater than that of the camera imaging device such that the focus camera can find optimal focus for objects that are not presently visible but may come into view of the camera imaging device.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

What is claimed is:

1. An imaging device, comprising:
a focus imaging unit;
a camera imaging unit separate from the focus imaging unit and configured to record an image;
a focusing unit coupled to the focus imaging unit and the camera imaging unit, and configured to adjust a focus position of the focus imaging unit and the camera imaging unit; and
a control unit coupled to the focusing imaging unit, the camera imaging unit, and the focusing unit, and configured to actuate the focusing unit to adjust the focus position of the focus imaging unit and to thereby determine an optimal focus position, and further configured to actuate the focusing unit to adjust the focus position of the camera imaging unit based on the determined optimal focus position.

2. The imaging device of claim 1, wherein the control unit utilizes a contrast analysis to determine the optimal focus position.

3. The imaging device of claim 1, wherein the focus imaging unit is configured to record monochromatic light and the camera imaging unit is further configured to record polychromatic light.

4. The imaging device of claim 1, wherein the focus imaging unit is configured to record a greater number of image frames per second than the camera imaging unit.

5. The imaging device of claim 1, in a hand-held device.

6. The imaging device of claim 1, wherein the camera imaging unit is further configured to capture video.

7. The imaging device of claim 1, wherein a field of view of the focus imaging unit is greater than the field of view of the camera imaging unit.

8. An imaging device, comprising:
a focus sensor configured to record an image;
a focus lens configured to position the image on the focus sensor;
a camera sensor configured to record the image;
a camera lens configured to position the image on the camera sensor;
a focusing assembly coupled to the focus lens and the camera lens, and configured to adjust placement of the image on the focus sensor and the camera sensor; and
a control unit coupled to the focusing assembly, the focus sensor, and the camera sensor, and configured to actuate the focusing assembly to determine an optimal focus of the image on the focus sensor, and further configured to actuate the focusing assembly to adjust the placement of the image on the camera sensor based on the determined optimal focus.

9. The imaging device of claim 8, wherein the control unit utilizes contrast differences in the image to determine the optimal focus position.

10. The imaging device of claim 8, wherein the focus sensor is configured to have a higher resolution than the camera sensor.

11. The imaging device of claim 8, further comprising a plurality of colored filters positioned between the camera sensor and the camera lens.

12. The imaging device of claim 8, wherein the focus sensor is further configured to record a greater number of frames per second than the camera sensor.

13. The imaging device of claim 8, in a hand-held device.

14. The imaging device of claim 8, wherein the camera sensor is further configured to capture video.

15. A non-transitory computer-readable storage medium storing instructions that, when executed by a processor, cause the processor to:
adjust a location of focus of a focus imaging unit for a first image of a first object;
determine an optimal focus location for the first image of the first object;
adjust a location of focus of a separate camera imaging unit for the first object based on the determined optimal focus location; and
record the first image of the first object on the camera imaging unit.

16. The non-transitory computer-readable storage medium of claim 15, further comprising stored instructions that, when executed by a processor, cause the processor to adjust an exposure of the focus imaging unit to enhance contrast of the first image.

17. The non-transitory computer-readable storage medium of claim 15, further comprising stored instructions that, when executed by a processor, case the processor to perform a contrast analysis on the first image during adjustment of the location of focus of the focus imaging unit to determine the optimal focus location for the first image of the first object.

18. The non-transitory computer-readable storage medium of claim 15, in a hand-held device.

19. The non-transitory computer-readable storage medium of claim 15, further comprising stored instructions that, when executed by a processor, case the processor to (i) adjust the location of focus of the focus imaging unit for a second image of a second object while the camera imaging unit continues to record the first image of the first object and (ii) determine the optimal focus location for the second image of the second object while the camera imaging unit continues to record the first image of the first object.

20. A method for use in an imaging device, comprising:
adjusting a location of focus of a focus imaging unit for a first image of a first object;
determining an optimal focus location for the first image of the first object;
adjusting a location of focus of a separate camera imaging unit for the first object based on the determined optimal focus location; and
recording the first image of the first object on the camera imaging unit.

21. The method of claim 20, further comprising adjusting an exposure of the focus imaging unit to enhance contrast of the first image.

22. The method of claim 20, further comprising performing a contrast analysis on the first image during adjustment of the location of focus of the focus imaging unit to determine the optimal focus location for the first image of the first object.

23. The method of claim 20, further comprising adjusting the location of focus of the focus imaging unit for a second image of a second object while the camera imaging unit continues to record the first image of the first object and determining the optimal focus location for the second image of the second object while the camera imaging unit continues to record the first image of the first object.
